(19) United States
(12) Patent Application Publication
(10) Pub. No.: US 2005/0109450 A1
(43) Pub. Date: May 26, 2005

(54) Laminate feeding in a card manufacturing device

(75) Inventors: John P. Skoglund, Savage, MN (US); Brent D. Lien, Minneapolis, MN (US); Andy A. Vander Woude, Eden Prairie, MN (US)

Correspondence Address: Brian D. Kaul;Westman, Champlin & Kelly, Suite 1600, 900 Second Avenue South, Minneapolis, MN, 55402-3319, US

(73) Assignee: Fargo Electronics, Inc., Eden Prairie, MN (US)

(21) Appl. No.: 10/995,900

(22) Filed: Nov. 23, 2004

Related U.S. Application Data
(60) Provisional application No. 60/525,536, filed on Nov. 25, 2003.

(51) Int. Cl. B32B 31/00

(52) U.S. Cl. 156/247; 156/555; 156/324

(57) ABSTRACT

A card manufacturing device includes a web of laminate material, a first set of feed rollers, and a aligning roller. The first set of feed rollers is configured to feed the web along a laminate feed path. The feed rollers each include an axis of rotation that is perpendicular to the laminate feed path. The aligning roller is configured to receive the web from the first set of feed rollers. The aligning roller includes a shaft having a skewed axis of rotation that is non-parallel to the axes of rotation of the first set of feed rollers, and a main roller that is supported on the shaft for rotation about the skewed axis. In accordance with one embodiment of the invention, the aligning roller includes a plurality of lugs that extend from the surface of the main roller to thereby form a paddlewheel.

The present application is based on and claims the benefit of U.S. provisional patent application Ser. No. 60/525,536, filed Nov. 25, 2003, the content of which is hereby incorporated by reference in its entirety.

### FIELD OF THE INVENTION

The present invention relates to a card manufacturing device, and more particularly, to methods and devices for using in a card manufacturing device for feeding a web of laminate material and separating an individual laminate section of the web from the remainder of the web.

### BACKGROUND OF THE INVENTION

Identification cards are commonly used as a vehicle for identifying the bearer of the card (e.g., driver's licenses) for access control, and other purposes. These identification cards are produced using identification card manufacturing systems, such as those produced by Fargo Electronics, Inc. of Eden Prairie, Minn.

Identification card manufacturing devices can perform many different card processing function. For example, card processing devices include printing devices for printing on a card, laminating devices for laminating a protective laminate on the card, card flipping devices for flipping the card, a data encoding devices for writing data to the card or to a chip embedded in the card, and other card processing devices. Often, the card processing devices mentioned above are combined into a single identification card processing device.

Card laminating devices have been configured to separate an individual identification card size protective transparent laminate section from a web or roll of overlaminate material, overlay a card with the separated laminate section, and laminate the laminate section onto the card automatically.

In the prior art, various structures have been advanced for laminating the transparent sections or “chips” onto a card, such as an identification card. The previous laminators have included a roll of a continuous web of the transparent laminate material, for example a roll of a clear polyester material. Preferably the web has weakened transverse lines that separate individual card size chips or segments. The weakened lines may be microperforated lines, and the sections defined can have scalloped edges that conform to the corners of the identification cards so that the individual protective sheet or chip can be separated automatically, and then aligned with a card or substrate on which it is to be laminated.

Many prior art card laminating devices have utilized a guillotine knife that would sever individual sheets from a roll of a web material. Cutters that use a scissors action for cutting are also known. Other prior art devices separated the individual sections using a snapping action, where a hump or ripple was formed in the web between two sets of rollers with a weakened transverse line also between the two sets of rollers. Once the hump is formed by slowing a lead roller, the lead roller is accelerated to snap the hump and create a tension across the weakened section or perforated line.

When laminating precisely sized segments of transparent sheets onto a pre-printed card, it is essential that the edges of the laminate align precisely with the edges of the card, or any overhang on any edge will be “picked” or abraded by the user so that the laminate will start to separate from the substrate or card after use. Such precise alignment is difficult to accommodate when the laminate sections are separated using the violent snapping the web to break the individual segments. Also snapping the web to break the individual segments can leave edges that are ragged and, thus, will not conform to the edges of the card. Knife cutting is slow and also can leave edge irregularities on the laminate as well as being unable to cut material in a shape that conforms to the card.

### SUMMARY OF THE INVENTION

One aspect of the present invention is directed to a card manufacturing device that includes a web of laminate material, a first set of feed rollers, and a aligning roller. The first set of feed rollers is configured to feed the web along a laminate feed path. The feed rollers each include an axis of rotation that is perpendicular to the laminate feed path. The aligning roller is configured to receive the web from the first set of feed rollers. The aligning roller includes a shaft having a skewed axis of rotation that is non-parallel to the axes of rotation of the first set of feed rollers, and a main roller that is supported on the shaft for rotation about the skewed axis. In accordance with one embodiment of the invention, the aligning roller includes a plurality of lugs that extend from the surface of the main roller to thereby form a paddlewheel.

Another aspect of the present invention is directed to a method of feeding a web of laminate material. In the method, a first set of feed rollers, and an aligning roller are provided. The aligning roller includes a shaft having a skewed axis of rotation that is non-parallel to axes of rotation of the first set of feed rollers and a main roller supported on the shaft for rotation about the skewed axis. Next, the web laminate is fed along a laminate feed path with the first set of feed rollers, and the web laminate is received by the aligning roller. Finally, the web laminate is fed along a second path that is skewed relative to the laminate feed path and is perpendicular to the skewed axis using the aligning roller.

Another aspect of the present invention is directed to a method of feeding a web of laminate material in a card manufacturing device. In the method, the guide fence and a web feeding mechanism including a aligning roller are provided. The guide fence is positioned alongside, and parallel to, a laminate feed path. The aligning roller includes a shaft having an axis of rotation that is non-perpendicular to the laminate feed path and the guide fence, and a main roller supported on the shaft for rotation about the axis. Next, a web of laminate material is fed with the aligning roller in a direction that is non-parallel to the laminate feed path and the guide fence, whereby the web is urged against the guide fence.

Yet another aspect of the present invention is directed to a method of feeding a web of laminate material in a card manufacturing device. In the method, a supply of laminate material having a plurality of laminate sheets joined end to end is provided. Additionally, first and second sets of feed rollers are provided. An end laminate sheet of the supply is driven with the first set of feed rollers in a forward direction along a laminate feed path. Next, a leading end of the end laminate sheet is held in place with the second set of feed rollers and the supply is driven in a rearward direction until the end laminate sheet separates from a remainder of the supply.

Other features and benefits that characterize embodiments of the present invention will be apparent upon reading the following detailed description and review of the associated drawings.

### BRIEF DESCRIPTION OF THE DRAWINGS

FIG. 1 is a perspective view of a supply web of laminate material illustrating the individual laminate sections that are separated by weakened lines extending transversely across the web.

FIG. 2 is a top plan view of a series of the individual laminate sections of the supply of FIG. 1.

FIG. 3 is a perspective view of an identification card with a laminate section laminated to the card.

FIG. 4 is a schematic side elevational view of the separating and laminating mechanism in accordance with embodiments of the invention.

FIG. 5 is a schematic top plan view of the mechanism of FIG. 3.

FIG. 6 is a fragmentary schematic front view taken generally along line 6-6 in FIG. 4 with parts broken away.

FIG. 7 is a block flow diagram illustrating methods of feeding and separating sections of the web, in accordance with embodiments of the invention.

### DETAILED DESCRIPTION OF THE ILLUSTRATIVE EMBODIMENTS

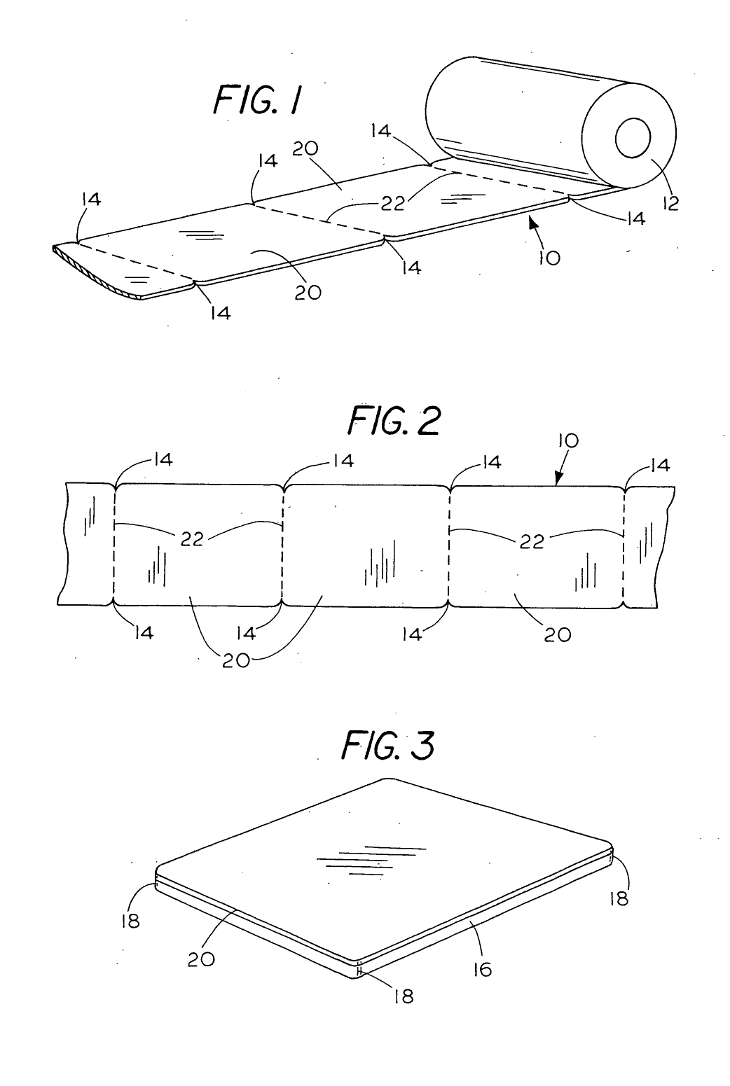

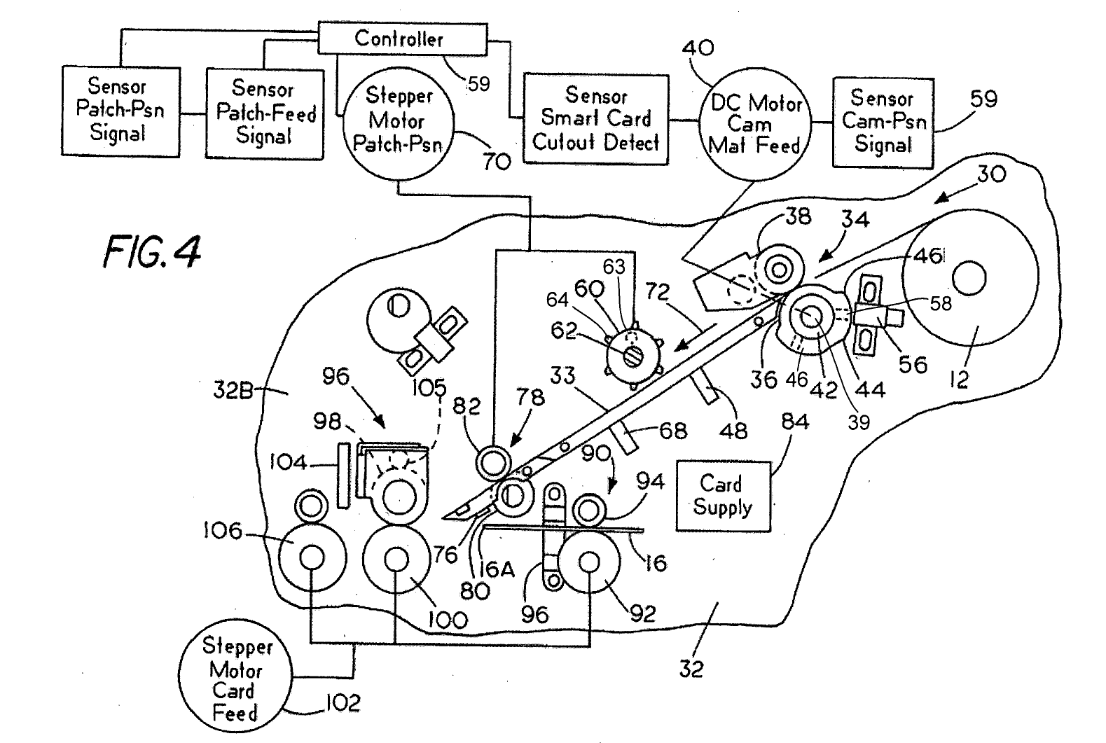

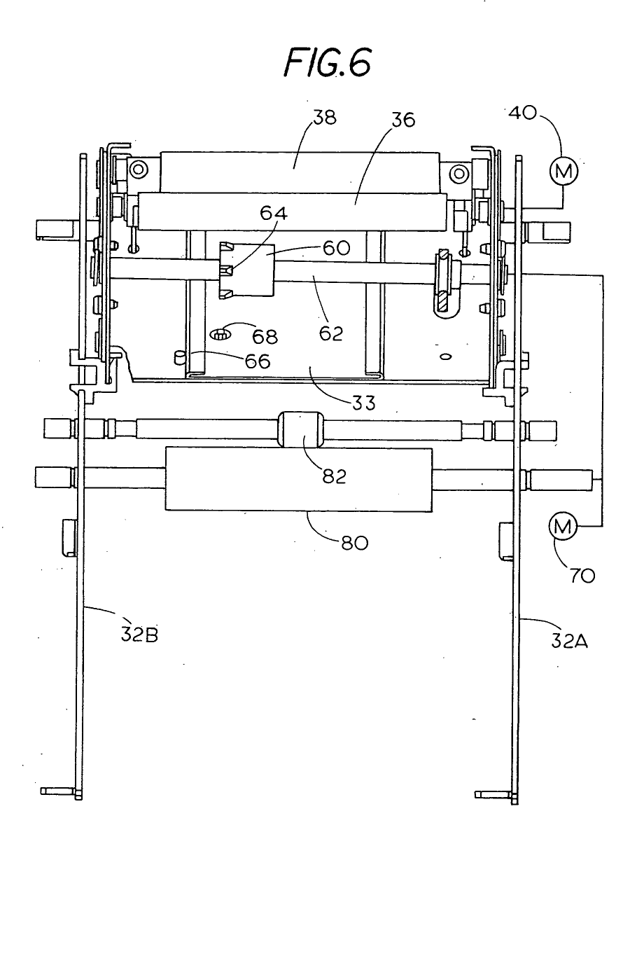

In FIGS. 1 and 2, a web 10 of laminate material, such as a clear polyester sheet or the like is illustrated. The web 10 is on a roll 12 that is supported on the frame of a card manufacturing device 30, which is shown in FIGS. 4-6. Web 10 of laminate material has a heat sensitive bonding or adhering layer on the underside that laminates the material to a substrate or card 16 (FIG. 3). The web 10 is provided with a plurality of evenly spaced, transversely aligning scallops or notches, indicated at 14, on opposite edges of the web. The scallops 14 are rounded to conform to the rounded corners 18 of a typical card 16. The scallops 14 align on opposite sides of the web and define ends of individual lamina segments or sheets 20 that lie along a transverse junction line 22. The line 22 is a weakened line, for example, micro-perforations through the web or other types of mechanical weakening are used. The transverse lines 22 are of lower tensile strength than the full strength web and extend transversely of the web to define the individual lamina sheets or segments 20.

The web 10 is divided into a plurality of individual lamina sheets or segments 20 that are a selected standard card size and shape, such as the size of a CR 80 identification card. The sheets or segments also could be many different sizes and shapes. The micro-perforations are longitudinally spaced so that the individual sheets 20 will be the same size as the card 16, or slightly smaller.

In FIG. 4, the card manufacturing device 30 is shown schematically in cross section. The device 30 can be any desired form, such as a conventional printer and/or laminator that includes the web feeding and handling device of the present invention. The device 30 includes an outer frame 32, comprising side plates 32A and 32B, with various frame support cross plates and shafts for rollers. A guide support plate or platform 33 is provided for the guiding the web 10 and the individual laminate sheets 20 as they are moved in a feeding direction.

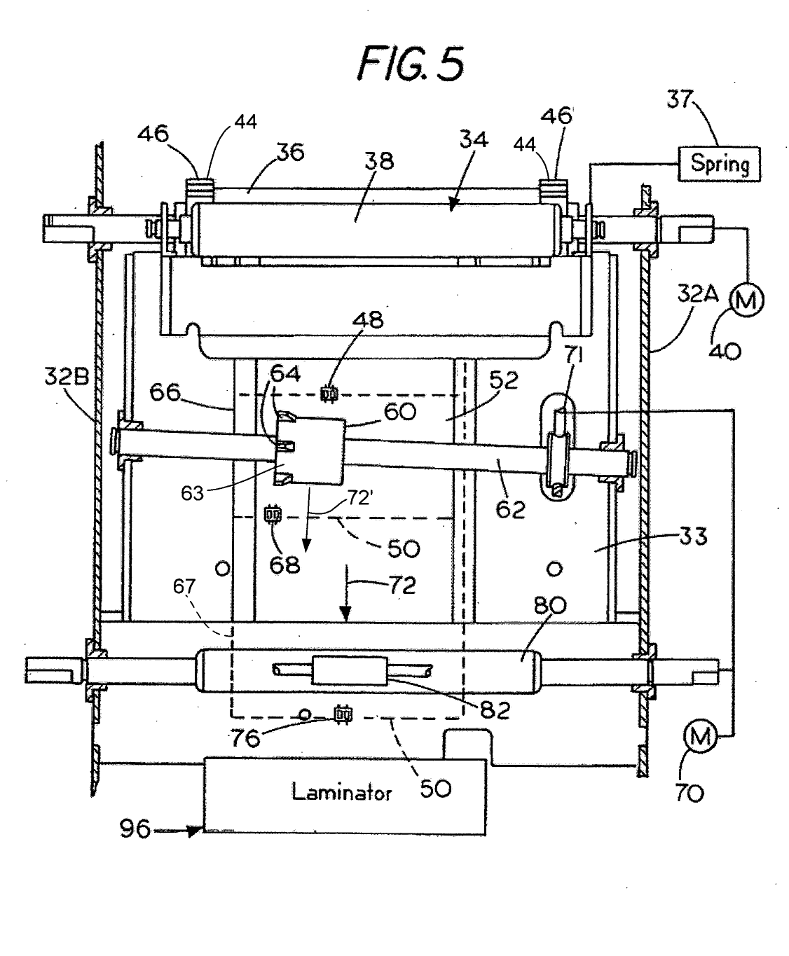

The roll 12 of the web material is mounted on the side plates 32A, 32B, and is preferably an non-powered, freely rotating roll. In other words, the hub of the roll 12 is not driven but a drag or light brake can be applied. The roll 12 is positioned so the web 10 is fed into a first set of feed and break rollers 34. The first set of rollers includes a driven or feed roller 36, and a spring loaded pinch roller 38 that is urged against the feed roller 36. A spring 37 (FIG. 5) loads the pinch roller 38. The drive roller 36 of the first set of rollers 34 can have a high coefficient of friction coating for ensuring a positive drive of the web.

A variable speed and reversible DC motor 40 is used for driving the feed roller 36. The feed roller 36 is mounted onto a shaft 39 and has a hub 42 that includes cam sections 44 at the ends of the roll, as shown in FIG. 4. The cam sections 44 each include one or more lobes 46 that are designed to lift the pinch roller 38 against the spring load of the spring 37 and away from the feed roller 36 during a selected portion of each revolution of the feed roller 36. The displacement of the pinch roller 38 from the feed roller 36 is due to the greater radial displacement of roller engaging surfaces of lobes 46 of the cam sections 44, as compared to other portions of the cam sections 44. Additionally, since the lobes 46 extend only partially around the periphery of the hub 42, they only displace the pinch roller 38 from the feed roller 36 during portions of the revolution of the feed roller 36.

Thus, the first set of rollers 34 move between feeding and release positions during the rotation of the feed roller 36. The first set of rollers 34 are in the feeding position when the lobes 46 of the cam sections 44 do not engage the pinch roller 38, and the feed roller 36 and the pinch roller 38 pinch a section of the web 10 therebetween, as shown in FIG. 4. While in the feeding position, the web 10 is driven in accordance with the driving of the feed roller 36. In accordance with one embodiment of the invention, the first set of rollers are in the feeding position during approximately 170 degrees of rotation of the feed roller 36.

The first set of rollers 34 move to the release position when the lobes 46 are rotated to engage the pinch roller 38 and displace it from the feed roller 36. When in this position, the web 10 is “released” and left substantially unrestrained by the first set of rollers 34. Accordingly, the web 10 can be moved independently of the first set of rollers 34 when they are in the release position.

The web 10 is fed along the upper surface of guide support plate 33 as it is driven by the first set 34 of feed and break rollers while they remain in the feeding position. During this feeding operation, as the web moves along the surface of plate 33, a first sensor 48 on the guide support plate 33 will sense the leading edge 50 of the leading end of an individual laminate section 52, as shown in FIG. 5.

The rotational position of the cam lobes 46 is detected by a sensor 56, shown in FIG. 4. Sensor 56 is an optical sensor that can reflect on a particular mark, for example a mark indicated at 58 on at least one of the cams. Alternative sensing methods can also be employed. The lobes 46 of the cam sections 44 can have marks 58 that allow each lobe 46 to be separately identifiable. The sensor 56 can also indicate which one of the cam lobes 46 is in the sensed position. When the mark 58 rotates to a position where it is sensed, the sensor 56 sends a signal to a controller 59 that controls the motor 40.

As mentioned above, sensor 48 indicates that leading end 50 of the web 10 is over that sensor, and the signal from sensor 48 is also used by the controller 59 for controlling the first set of rollers 34. The signal from sensor 48 can be used for stopping any further movement of the web until lamination of a previously separated laminate sheet 20 has been completed.

However, assuming that a separating operation is to commence to separate the end laminate section 52 from the remainder of the web 10, a signal to the motor 40 will drive the first set of feed and break rollers 34 and move the leading end edge 50 of the end individual laminate sheet or section 52 forwardly along a laminate feed path (indicated by arrow 72 in FIGS. 4 and 5), which is perpendicular to axes of rotation of the feed and pinch rollers 36 and 38, until web upper surface is engaged by an aligning roller 60.

The aligning roller 60 is mounted on a shaft 62 and a main roller 63 on the shaft. The shaft 62 and the main roller 63 share an axis of rotation that is skewed relative to the axes of rotation of the feed and pinch rollers 36 and 38 of the first set of feed rollers 34. Therefore, the axis of rotation of the aligning roller is skewed or is non-perpendicular to the laminate feed path (arrow 72), which is oriented perpendicular to the axis of rotation of the first set of feed rollers 34.

The aligning roller 60 operates to feed or urge the web 10 generally in a forwardly direction 72′ (FIG. 5) that is angled relative to the laminate feed path toward a guide fence 66. The guide fence 66 extends vertically from alongside the guide support plate 33 and is preferably oriented parallel to the laminate feed path. The feeding of the web 10 with the aligning roller urges the web 10 toward the fence 66, such that an edge 67 (FIG. 5) of the web 10 becomes aligned with the fence 66. As a result, a location of the edge 67 becomes known for use in aligning the web 10 with a card 16 prior to laminating the web to the card.

In accordance with one embodiment of the invention, the aligning roller 60 feeds the web 10 through contact with the surface of the main roller 63. However, one problem with this arrangement is that the feeding force (i.e., frictional force) that is applied by the surface of the main roller 63 against the web 10 is strong enough to continue to drive the web 10 into the fence 66 even after the edge 67 has engaged the fence 66. In other words, the counter force that is applied to the feeding force by the web 10 due to the abutment of the edge 67 against the fence 66 is insufficient to overcome the feeding force. As a result, the web 10 may buckle against the fence 66 causing undesirable wrinkles to form in the web 10 and making the web 10 unsuitable for a laminating operation. This is particularly, problematic for conventional web laminates that are formed of very thin material.

This problem is solved by another embodiment of the aligning roller 60 that includes a plurality of projections or lugs 64 extending from a surface of the main roller 63, as shown in FIGS. 4 and 5, thereby making the aligning roller 60 a “paddlewheel”. Preferably the lugs 64 extend radially from the surface of the main roller 63 and are the only portion of the aligning roller or paddlewheel 60 that contacts the web 10 or laminate section 52 for feeding purposes.

The lugs 64 are preferably designed such that the feeding force that they apply to the laminate section 52 of the web 10 to feed or urge the laminate section 52 against the fence 66 and along the laminate feed path does not disrupt the alignment between the edge 67 of the web 10 and the fence 66 once it is achieved, or cause major wrinkles to form in the web 10.

In accordance with one embodiment of the invention, the feeding force (i.e., frictional force) applied to the web 10 by the lugs 64 during rotation of the main roller 63 is too weak to cause the laminate section to buckle against the fence 66. Here, the lugs 64 apply a reduced frictional force to the surface of the laminate section 52 during rotation of the paddlewheel 60, as compared to traditional feeding rollers, such as feeding and pinch rollers 36 and 38.

The amount of frictional force that is applied to the laminate section 52 by the lugs 64, depends on the material used to form them the lugs 64, the shape of the lugs 64, the number of lugs 64, and the length of the lugs 64.

The material used to form the lugs 64 can be chosen to have either a high or low coefficient of friction. Additionally, the material can be chosen to be flexible or stiff. Each of these properties will have an effect on the force delivered to the sheet 52 by the paddlewheel 60.

The shape and number of the lugs 64 will also affect the force applied to the sheet 52, because those factors determine a surface area of contact between the lugs 64 and the sheet 52. The greater the contact area, the larger the frictional force that can be applied.

Finally, the length of the lugs 64 will have an affect on the contact area between the lugs 64 and the sheet 52. Additionally, the length of the lugs 64 will affect the flex in the lugs, which in turn will affect the normal force that is applied to the sheet 52 by the lugs 64. The larger the normal force that is applied between a lug 64 and the sheet 52, the greater the frictional force that can be applied to the sheet by the lug 64.

In accordance with another embodiment of the invention, the feeding force is intermittently applied by the lugs 64 to the web 10 during rotation of the paddlewheel 60. This is made possible by the angular spacing of the lugs 64 around the surface of the main roller 63, as shown in FIG. 4. As a result, the lugs 64 are periodically free from contact with the web 10 during the rotation of the paddlewheel 60.

Thus, when a buckle forms in the web 10, the force applied to the web 10 at the fence 66 by the buckle is sufficient to flatten the buckle on the support plate 33, which preferably has a low coefficient of friction, during the temporary period in which the feeding force applied by the lugs 64 is relieved. The temporary relief period can be adjusted by simply adjusting the angular spacing of the lugs 64. As a result, this embodiment of the invention allows the feeding force applied by the lugs 64 to be larger than that applied when the feeding force is applied in a nearly constant manner to the web 10 during rotation of the paddlewheel 60.

The feeding of the web 10 by the aligning roller 60, preferably occurs without resistance from the first set of feed rollers 34. In accordance with one embodiment of the invention, the device 30 includes a sensor 68 adjacent the platform 33 on the downstream side of paddlewheel 60, relative to the forward feeding direction. The sensor 68 is configured to sense the leading edge 50 of the leading laminate sheet 52. Once the sensor 68 detects the leading edge 50, the roller 36 of the first set of feed rollers 34 is driven to the release position, in which one of the cam lobes 46 engages the pinch roller 38 and displaces the pinch roller 38 away from the web 10. As a result, the web is substantially unrestrained by the first set of rollers 34.

While the first set of rollers 34 is in the release position, the leading end sheet or section 52, which is still attached to the web 10, is driven by the aligning roller 60 to be aligned precisely with the end of a card or substrate that will be fed, and on which the laminate sheet or section 52 will be laminated. The aligning roller 60 is driven with a stepper motor 70 and drive member 71 under the control of the controller 59, to move the web 10 generally in the forward direction, as indicated by arrow 72 (FIG. 4) and 72′ (FIG. 5), without significant resistance from the first set of rollers 34. As discussed above, the web 10 is moved laterally against the guide fence 66 by the rotation of the aligning roller 60 to align the edge 67 of the web 10 against the fence 66.

Thus, the aligning roller 60 is preferably the sole drive for the web 10, once the sensor 68 has caused the first set of rollers 34 to move to the release position, until the end section position sensor 76 senses the leading edge 50 of the end laminate sheet or section 52. The leading edge 50 is shown in dotted lines adjacent to sensor 76 in FIG. 5.

The leading edge 50 that is shown in dotted lines will be advanced beyond the sensor 76 a selected amount, as precisely driven by the stepper motor 70, and the end laminate section or sheet 52 will have entered and passed through a second set of feed rollers 78, called placement rollers, that includes a placement drive roller 80 and a spring loaded pinch roller 82.

Once the sensor 76 has indicated that the web 10, and in particular the leading end laminate sheet or section 52, is held in the second set of rollers 78, it is known that that the end of the section 52 will be securely held because the pinch roller 82 will be exerting a clamping force down onto the drive roller 80 while the drive roller 80 is not allowed to rotate.

The signal from the sensor 76 is then used to reverse the motor 40 to thereby rotate the feed roller 36 to a position where the cams 44 are rotated to place the first set of rollers 34 in the feeding position and cause the pinch roller 38 to clamp the web 10 against the feed roller 36. In this position, the length of the end sheet or section 52 is such that the weakened line that is shown at 22 in FIGS. 1 and 2, for example, will generally be in the region overlying the sensor 48, and at least between the first and second sets of rollers 34 and 78, but preferably between the drive lugs 64 on the aligning roller 60 and the first set of rollers 34. The drive roller 36 is then driven in reverse to drive the web 10 in a rearward direction (i.e., opposite the forward direction 72) along the laminate feed path to thereby create enough tension in the web 10 to separate the end laminate section 52 from the remainder of the web 10.

Once separation of the section 52 from the remainder of the web 10 has occurred, which is known to occur with a certain amount of rotation of the roller 36, the roller 36 is preferably stopped and the web 10 is held in position at the first set of rollers 34 while further processing of the separated end laminate sheet or section 52 takes place.

In accordance with one embodiment of the invention, the device 30 is configured to laminate the separated laminate section 52 to a card 16. The sensor 76 provides a positive, known location of the leading edge of the separated laminate sheet 52 that will be laminated onto a card 16. Additionally, a location of the side edge 67 of the laminate section 52 is known due to its alignment with the fence 66.

A card 16 is fed from a card supply 84 is on the frame 32 into a set of card feed rollers 90 which include a drive roller 92 and a spring loaded pinch roller 94, for example. A card position sensor 96 senses when the leading end edge 16A of card 16 is extending from the rollers 92 and 94, as shown in FIG. 4. Additionally, a location of a side edge of the card that is perpendicular to the leading edge 16A is known by feeding the card 16 along or through a suitable card guide.

With the precise locations of the leading and side edges of the card 16 and the laminate section 52 known, set of card feed rollers 90 are driven to bring the card 16 into a known position adjacent the end of the guide support plate 33 and the separated end laminate section 52 is driven by the roller set 78 simultaneously with the card 16, once the sensors show that the laminate section leading edge 50 and the leading edge 16A are precisely aligned or indexed.

The separated laminate sheet or section 52 and the card 16 are then fed together into a laminator 96, which includes a heated roll illustrated schematically at 98, and a drive roll 100. A stepper motor 102 is used for driving the drive roll 100, and the lamination takes place because of the heat and pressure applied by the heated roll 98. A thermocouple 104 can be used for sensing the temperature of the heated laminator roll to control a cartridge heater, shown in dotted lines at 105, to maintain the temperature of roll 98 at a desired level so that lamination will occur reliably.

A pair of laminated card drive rollers 106 are configured to drive the card after lamination to a desired position. For example, a card “flipper” can be used for inverting the card, so that the side that did not receive the laminate sheet or section on a first pass would be facing up. The card could then be fed back through the rollers 100 to be held by the roller set 90 until another laminate sheet or section has been fed down to the sensor 76.

This procedure for laminating on both sides of a card is carried out at the present time, and the card inverter can be of the type shown in U.S. Pat. No. 6,279,901 B1 issued Aug. 28, 2001.

In summary, the sheet separation mechanism will feed an end portion of the web to a set of feed rollers that hold the web, and then a set of feed/break rollers engage the web on an upstream or opposite side of a weakened line on the web while the end sheet or section of the web is held in place by the second set of feed and pinch rollers. The reversal insures that the web sheet or section that is to be fed is held securely in its known position so that it will be indexed properly with the card to be laminated.

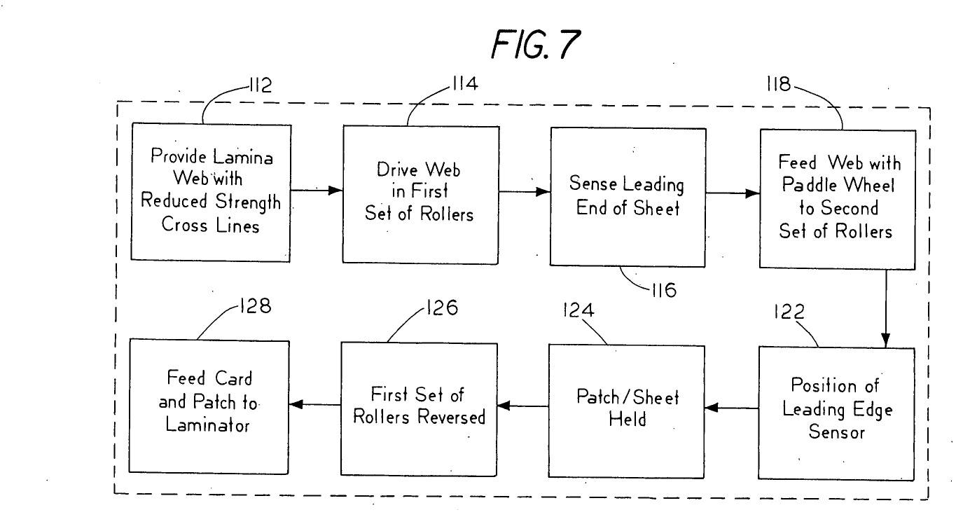

FIG. 7 is a flow diagram of the method. The block 112 indicates that a laminate web is provided, which has reduced strength cross lines. Then, the web is driven as indicated at 114 with a first set of rollers that are feed and break rollers, and which rollers can be separated during a portion of the roller rotation. Sensing the leading end edge is indicated at 116, and then the web is fed with an alignment paddle wheel only, as indicated at 118. The gripping action of the first set of rollers is released by separating them with a cam.

Also, as indicated in block 118 the web is driven to a second set of rollers, and the position of the leading edge is sensed as indicated at block 122. The laminate section or patch is held by the second set of rollers, as indicated by block 124, and the first set of feed/break rollers is reversed as indicated by block 126 to separate the end laminate sheet or section from the rest of the web. The card and laminate sheet or section are then fed to the laminator for processing.

The reversing of the first set of feed and break rollers while the end section is held eliminates the need for any type of a snapping action.

An additional feature is that the alignment of the side edge of the separated web sheet or section is urged against a guide fence with an aligning roller that, in accordance with one embodiment of the invention, has projections or lugs that urge the edge of the web against the guide fence at the same time the lugs drive the web in the forward feed direction, uninhibited by the first set of feed and break rollers.

Although the present invention has been described with reference to preferred embodiments, workers skilled in the art will recognize that changes may be made in form and detail without departing from the spirit and scope of the invention.

1. A card manufacturing device comprising:
a web of laminate material;
a first set of feed rollers configured to feed the web along a laminate feed path; and
an aligning roller configured to receive the web from the first set of feed rollers, the aligning roller including a shaft having a skewed axis of rotation that is non-parallel to axes of rotation of the first set of feed rollers, and a main roller supported on the shaft for rotation about the skewed axis.

2. The device of claim 1, wherein the aligning roller includes a plurality of lugs extending from a surface of the main roller, thereby forming a paddlewheel.

3. The device of claim 2, wherein the lugs extend radially from the surface of the main roller.

4. The device of claim 2 including a guide support plate in the laminate feed path configured to support the web as it is fed, wherein the web is received between the paddlewheel and the guide support plate.

5. The device of claim 4 including a guide fence positioned alongside the laminate feed path and oriented perpendicularly to the guide support plate and parallel to the laminate feed path, wherein the paddlewheel is configured to drive the web along the laminate feed path in a forward direction and against the guide fence.

6. The device of claim 5, wherein the skewed axis of rotation is non-perpendicular to the guide fence.

7. The device of claim 5, wherein the first set of feed rollers include a feeding position in which the web is pinched between the first set of feed rollers, and a release position in which the web is not restrained by the first set of feed rollers.

8. The device of claim 7 including cam sections mounted to ends of one of the first set of feed rollers, the cam sections directing the first set of feed rollers between the feeding and release positions in response to a rotation of the cam setting.

9. The device of claim 2, wherein:
the paddlewheel is located downstream of the first set of feed rollers along the laminate feed path relative to the forward direction; and
the device includes a second set of feed rollers located downsteam of the paddlewheel and configured to clamp the web in place while the first set of feed rollers drive the web in a reverse direction that is opposite the forward direction to thereby separate a laminate section of the web along a weakened line located between the first and second sets of feed rollers.

10. The device of claim 9 including a laminator configured to laminate the laminate section to a surface of a card.

11. The device of claim 10 including a card feeder configured to feed the card in alignment with the laminate section.

12. The device of claim 9 including a sensor located downstream of the second set of feed rollers and configured to produce a signal that indicates that the web has been fed between the second set of feed rollers.

13. The device of claim 2 including a sensor located downstream of the paddlewheel relative to the forward direction and configured to sense a leading edge of the web.

14. In a card manufacturing device, a method of feeding a web of laminate material comprising steps of:
a) providing a guide fence positioned alongside, and parallel to, a laminate feed path;
b) providing a web feeding mechanism including an aligning roller having a shaft including an axis of rotation that is non-perpendicular to the laminate feed path and the guide fence, and a main roller supported on the shaft for rotation about the axis; and
c) feeding a web of laminate material with the aligning roller in a direction that is non-parallel to the laminate feed path and the guide fence, whereby the web is urged against the guide fence.

15. The method of claim 14, wherein the aligning roller includes a plurality of lugs extending from a surface of the main roller to thereby form a paddlewheel.

16. The method of claim 15, wherein the feeding step c) includes applying a feeding force to the web using the lugs of the paddlewheel that urges the web toward the guide fence.

17. The method of claim 16, wherein the feeding force is applied to the web intermittently during the feeding step c).

18. The method of claim 14 including:
providing a first set of feed rollers positioned upstream of the aligning roller relative to a forward feeding direction of the web, the first set of feed rollers including a feeding position in which the web is pinched between the first set of feed rollers, and a release position in which the web is not restrained by the first set of feed rollers; and
placing the first set of feed rollers in the release position prior to the feeding step c).

19. The method of claim 15 including a step of d) sensing a leading edge of the web, whereby a location of the leading edge of the web is known and a location of a side edge of the web is known by the feeding step c).

20. The method of claim 19 including aligning the leading and side edges of the web to corresponding edges of a card.

21. The method of claim 20 including:
separating a laminate section from the web along a line of reduced strength; and
laminating the laminate section to a card.

22. In a card manufacturing device, a method of feeding a web of laminate material comprising:
a) providing a supply of laminate material having a plurality of laminate sheets joined end to end;
b) providing first and second sets of feed rollers;
c) driving an end laminate sheet of the supply with the first set of feed rollers in a forward direction along a laminate feed path;
d) holding a leading end of the end laminate sheet in place with the second set of feed rollers; and
e) driving the supply in a rearward direction with the first set of feed rollers during the holding step d) until the end laminate sheet separates from a remainder of the supply.

23. The method of claim 22 including providing an aligning roller between the first and second sets of feed rollers, the aligning roller including a shaft having a skewed axis of rotation that is non-parallel to axes of rotation of the first set of feed rollers, and a main roller supported on the shaft for rotation about the skewed axis.

24. The method of claim 23, wherein the aligning roller includes a plurality of lugs extending from a surface of the main roller to thereby form a paddlewheel.

25. The method of claim 24 including, prior to the holding step d):
receiving the end laminate sheet from the first set of feed rollers with the paddlewheel;
feeding the end laminate sheet with the paddlewheel in a direction that is non-parallel to the laminate feed path and non-perpendicular to the first set of feed rollers; and
feeding the leading end to the second set of feed rollers.

26. The method of claim 25 including feeding the end laminate sheet against a guide fence positioned alongside the laminate feed path.

27. The method of claim 23 including, prior to the holding step d):
i) receiving the end laminate sheet from the first set of feed rollers with the aligning roller;
ii) moving the first set of feed rollers from a feeding position in which the first set of feed rollers pinch one of the laminate sheets to a release position in which the laminate sheets are not restrained by the first set of feed rollers; and
iii) feeding the end laminate sheet with the aligning roller.

28. The method of claim 27, wherein the feeding step iii) includes feeding the end laminate sheet in a direction that is non-parallel to the laminate feed path and non-perpendicular to the axes of rotation of the first set of feed rollers.

29. The method of claim 28, wherein the aligning roller includes a plurality of lugs extending from a surface of the main roller.

30. The method of claim 29, wherein the feeding step iii) includes applying a feeding force to the end laminate sheet with the lugs.

31. The method of claim 30, wherein the feeding force is applied to the end laminate sheet intermittently.

34. In a card manufacturing device, a method of feeding a web of laminate material comprising:
a) providing a web of laminate material;
b) providing a first set of feed rollers;
c) providing an aligning roller including a shaft having a skewed axis of rotation that is non-parallel to axes of rotation of the first set of feed rollers and a main roller supported on the shaft for rotation about the skewed axis;
d) feeding the web laminate along a laminate feed path with the first set of feed rollers;
e) receiving the web laminate with the aligning roller; and
f) feeding the web laminate along a second path that is skewed relative to the laminate feed path and is perpendicular to the skewed axis using the aligning roller.

35. The method of claim 34, wherein the aligning roller includes a plurality of lugs extending from a surface of the main roller to thereby form a paddlewheel.

36. The method of claim 35, wherein the feeding step f) includes applying a feeding force to the web with the lugs.

37. The method of claim 36, wherein the feeding force is applied to the web intermittently during rotation of the aligning roller.

38. The method of claim 35, wherein:
the first set of feed rollers include a feeding position in which the web is pinched between the first set of feed rollers, and a release position in which the web is not restrained by the first set of feed rollers; and
the method includes placing the first set of feed rollers in the release position prior to the feeding step f).

39. The method of claim 35, wherein the feeding step f) includes feeding the web laminate along the second path toward a guide fence, whereby an edge of the web laminate becomes aligned with the guide fence.
